(19) United States
(12) Patent Application Publication
(10) Pub. No.: US 2022/0192095 A1
(43) Pub. Date: Jun. 23, 2022

(54) MOWER PROPULSION APPARATUS INCLUDING A SPLIT TRANSAXLE

(71) Applicant: Honda Motor Co., Ltd., Tokyo (JP)

(72) Inventors: Travis BARKEY, Greensboro, NC (US); Christopher D. MEEKS, Greensboro, NC (US); Nathaniel A. LENFERT, Graham, NC (US); Christopher W. VAUGHN, Mebane, NC (US); Scott J. KASKAWITZ, Hillsborough, NC (US)

(21) Appl. No.: 17/129,544

(22) Filed: Dec. 21, 2020

(51) Int. Cl. A01D 69/03; A01D 34/66; A01D 67/00; B60K 7/00; B60G 7/00; B60G 15/06

(52) U.S. Cl. CPC A01D 69/03; A01D 34/66; A01D 67/00; A01D 2101/00; B60G 7/001; B60G 15/062; B60K 7/0015

(57) ABSTRACT

According to some embodiments of the disclosed subject matter, a ride-on mower can include a main frame, a side member pivotally connected to the main frame, and a transaxle. The transaxle can include a pump portion that has a pump housing fixed on the main frame and a fluid displacement structure located in the pump housing. The transaxle can further include a motor portion including a motor housing and a fluid driven structure located in the motor housing. The motor housing can be separate from the pump housing, and the motor housing can be carried on and movable with the side member. Tubing can interconnect the pump portion and the motor portion.

### BACKGROUND

The disclosed subject matter relates to a mower propulsion apparatus that includes a split transaxle. More particularly, the disclosed subject matter relates to a fluid power transaxle that includes a motor portion that is movable relative to a fixed pump portion.

Self-propelled lawnmowers can be configured for the user to walk behind the lawnmower, ride on the lawnmower, or ride on a sulky trailered to the lawnmower. A riding lawnmower (also referred to as ride-on lawnmower or a ride-on mower) can include three or more wheels and can be driven by at least one of the wheels. The wheels can be rigidly connected to the main frame. Alternatively, at least one of the wheels can be connected to the frame by a suspension member with or without a damper assembly connected to the suspension member and the main frame.

Self-propelled lawnmowers can include different types of propulsion systems such as but not limited to an internal combustion engine or all electric zero turn riding (ZTR) mowers that drive a geared transmission directly connected to the engine or connected by a belt and pulleys, or drives a continuously variable transmission that uses a belt and adjustable pulleys, or drives a hydrostatic transmission. The propulsion apparatus can drive one of the wheels, or more than one of the wheels of the lawnmower.

A hydrostatic transmission can use hydraulic pressure to drive at least one of the wheels of the lawnmower. The hydrostatic transmission can include a pump that supplies pressurized hydraulic fluid to a hydraulic motor. The pressurized hydraulic fluid can act on fluid driven structure(s) of the motor to cause the motor to rotate the drive wheel(s) of the lawnmower and propel the lawnmower. The pump can be driven by the internal combustion engine or electric motor, etc.

### SUMMARY

Some embodiments of the presently disclosed subject matter are directed to a ride-on mower that can include a main frame, a side member pivotally connected to the main frame, and a transaxle. The transaxle can include a pump portion including a pump housing fixed on the main frame and a fluid displacement structure located in the pump housing, a motor portion including a motor housing and a fluid driven structure located in the motor housing, the motor housing being separate from the pump housing, and the motor housing being carried on and movable with the side member, and tubing interconnecting the pump portion and the motor portion.

Further embodiments are directed to a self-propelled lawnmower that can include a main frame, a power source attached to the main frame, a mower deck connected to the main frame and including at least one cutting chamber, at least one blade located in each cutting chamber, a plurality of wheels connected to the main frame, a suspension member connected to the main frame, the suspension member configured to move with respect to the main frame, and the suspension member configured to rotationally support at least one of the wheels, and a transaxle. The transaxle can be configured to selectively drive at least one of the wheels, and can include one of an operating pump and motor pump fixed on the main frame, an other of the operating pump and the motor pump fixed on the suspension member, such that the motor pump moves with respect to the operating pump when the suspension member moves relative to the main frame, and tubing interconnecting the operating pump and the motor pump. The motor pump could include or be replaced with an electric drive motor.

Additional embodiments are directed to a lawnmower that can include a main frame, a power source mounted on the main frame, a cutting chamber connected to the main frame, at least one blade located in the cutting chamber, a pair of suspension arms having a first end and extending to a second end, the first end is pivotally connected to the main frame such that each of the suspension arms pivots with respect to the main frame, a pair of dampers connected to the main frame, each of the dampers is connected to the second end of a respective one of the suspension arms, a pair of drive wheels rotatably supported by the suspension arms, and a first transaxle. The first transaxle can include, a pump portion including a pump housing fixed on the main frame and a fluid displacement structure located in the pump housing, a motor portion including a motor housing and a fluid driven structure located in the motor housing, the motor housing being spaced from the pump housing, the motor housing being carried on and moving with the respective one of the suspension arms, and the fluid driven structure being connected to and selectively driving a respective one of the drive wheels, and tubing interconnecting the pump portion and the motor portion.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of a lawnmower with wheels in phantom, made in accordance with principles of the disclosed subject matter.

FIG. 2 is a partial bottom view of the lawnmower of FIG. 1.

FIG. 3 is a perspective view of a lower rear portion of the lawnmower of FIG. 1.

FIG. 4 is a perspective view of a transaxle and a rear suspension assembly of the lawnmower of FIG. 1.

FIG. 5 is a top view of the transaxle and the rear suspension assembly of FIG. 4.

FIG. 6 is schematic illustration of the transaxle of FIGS. 4 and 5.

FIG. 7 is an enlarged view of a portion of FIG. 2 with a pump mount plate removed to expose the rear suspension assemblies and the transaxles.

FIG. 8 is a partial bottom perspective view of a rear portion of the lawnmower of FIG. 1 with the pump mount plate removed to expose the rear suspension assemblies and the transaxles.

FIG. 9 is a perspective view of an outer side of a suspension assembly of the lawnmower of FIG. 1.

FIG. 10 is a perspective view of an inner side of the suspension assembly of FIG. 9.

FIG. 11 is a cross-sectional view taken along line 11-11 of FIG. 9.

FIG. 12 is a front view of another embodiment of a suspension assembly with schematic representation of a motor pump and operating pump made in accordance with principles of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

A ride-on lawnmower can include at least one steerable wheel and at least one driven wheel. The steerable wheel can pivot relative to a frame of the lawnmower in order to change the direction of travel of the lawnmower when moving forward or backward.

An alternate embodiment of a ride-on lawnmower can include a pair of independently driven wheels such as tires, tracks, or other known ground driving mechanisms. An operator can control the direction of travel by controlling the direction in which each drive wheel is driven. For example, to travel forward along a straight path, the operator can cause both drive wheels to be driven in the same rotational direction and at the same rotational speed. The operator can steer the lawnmower by causing one of the drive wheels to rotate faster in the same direction as compared to another one of the wheels. Further, the operator can cause the lawnmower to spin about a yaw axis by causing one of the drive wheels to rotate in a first rotational direction and the other of the drive wheels to rotate in a second rotational direction that is opposite to the first rotational direction. This type of ride-on lawnmower can be referred to as a zero turn radius (“ZTR”) lawnmower or as a zero turn lawnmower.

In order to improve operator comfort, the drive wheel(s) can be suspended from a frame of the lawnmower with a suspension assembly that includes at least one moveable linkage and a damper such as a shock absorber, spring, spring with damper, strut, etc. The drive wheel(s) can be supported by a common suspension member. Alternate embodiments can include a suspension assembly for each drive wheel such that each drive wheel can move independently of the other drive wheel. The drive wheels can be configured as a rim with rubber tire located thereon. Alternatively, the drive wheels can be configured as a drive rim (or drive gear) that work in cooperation with at least one other drive rim or drive gear with a track fitted thereabout, such as are known in other tracked vehicles such as snowmobiles, bulldozers, etc.

Exemplary embodiments of a ride-on lawnmower can include a hydrostatic transmission (HST) or drive motors. The lawnmower with steerable wheels can include a single HST that drives at least one wheel. The ZTR lawnmower can include a pair of HST's or drive motors, one for each drive wheel. Each HST or drive motor can include an input pulley that is driven by a belt that is driven by an output pulley connected to a source of torque such as an internal combustion engine, electric motor, hybrid motor or other known power source. The source of torque can also be referred to as a power source.

The hydrostatic transmission(s) can be mounted on the suspension member(s) such that the HST moves with the suspension member. As a result, the input pulley of the HST can move relative to the output pulley. This relative movement can stretch and/or twist the belt and can cause the belt to disengage from one or both of the pulleys. This relative movement can cause extra wear on the drive belt that can adversely impact the operational life of the drive belt, and can also cause damage to the HST itself due to harsh movements during operation.

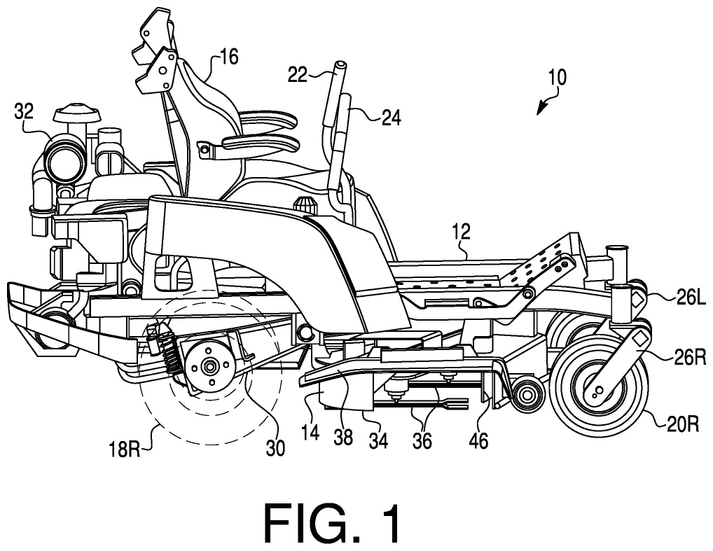

FIG. 1 illustrates an embodiment of a ride-on lawnmower 10 made in accordance with principles of the disclosed subject matter. The lawnmower 10 can include a suspension assembly and an HST layout that can provide an advantageous comfort level for the operator while mitigating or avoiding the undesirable wear on the drive belt, HST, and transaxle components. The suspension assembly and HST layout can also reduce the frequency at which the belt disengages from one or both the HST input pulley and the power source output pulley as compared to the conventional layout in which the HST input pulley moves with the suspension assembly. In particular, the HST can be formed as a split transaxle in which an operating pump 501 is attached to a main frame 12 of the lawnmower 10, and a motor pump 401 is attached to a suspension assembly 30. The suspension assembly 30 can pivot or otherwise be moveable with respect to the main frame 12 to provide a level of damping to the ride characteristics of the lawnmower 10.

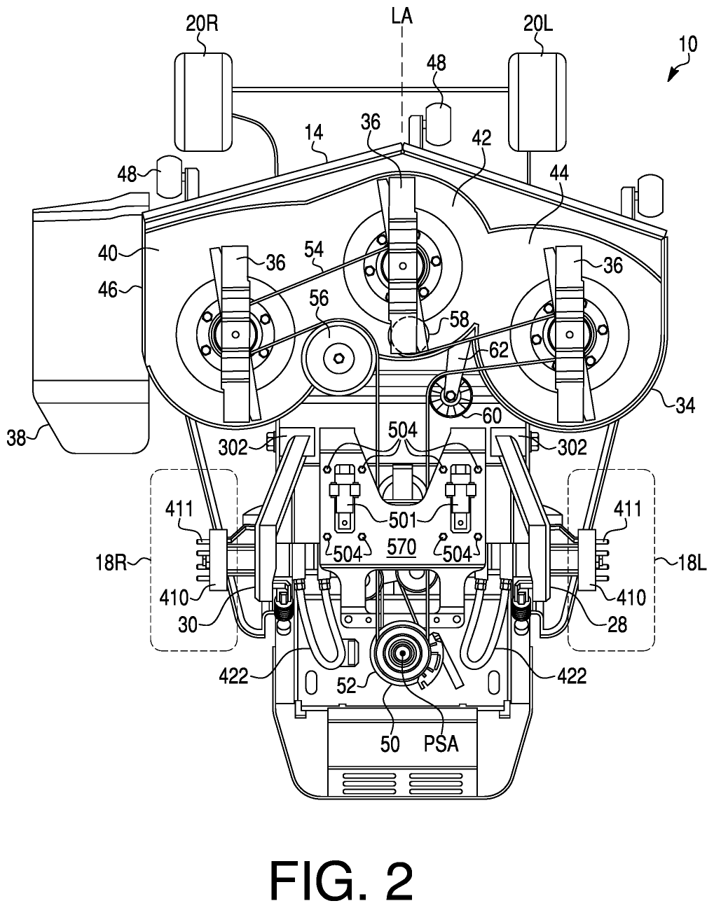

The lawnmower 10 can include the main frame 12, a mower deck 14, a seat 16, a pair of drive wheels 18L, 18R, a pair of caster wheels 20L, 20R, a pair of control levers 22, 24, a pair of front forks 26L, 26R, a pair of suspension assemblies 28, 30 and a power source 32. The left drive wheel 18L is omitted from FIG. 1 and the left suspension assembly 28 is obstructed from view in FIG. 1. The right drive wheel 18R is shown in phantom in FIG. 1 in order to more clearly illustrate the right suspension assembly 30. FIG. 2 shows both drive wheels 18L, 18R in phantom. FIGS. 2, 7 and 8 show both suspension assemblies 28, 30.

Referring to FIG. 1, the main frame 12 can support the seat 16, the control levers 22, 24 and the power source 32. The mower deck 14 can be suspended from the main frame 12. Each of the drive wheels 18L, 18R can be connected to the main frame 12 by a respective suspension assembly 28, 30. The main frame 12 can pivotally support the front forks 26L, 26R, and the front forks 26L, 26R can rotatably support the caster wheels 20L, 20R.

The mower deck 14 can be referred to as a deck, a deck assembly, a blade deck, a cutter housing, or a cutter housing assembly. Referring to FIGS. 1 and 2 collectively, the mower deck 14 can include a housing 34 that houses a plurality of blade assemblies 36. The housing 34 can include a plurality of cutting chambers 40, 42, 44, a discharge opening 46 with discharge chute guard 38. A plurality of wheel assemblies 48 can keep the mower deck 14 at a constant height above the ground over which the lawnmower 10 traverses. Each of the blade assemblies 36 can include one blade or a pair of blades rotationally offset with respect to one another. The discharge chute guard 38 can be pivotally mounted to the housing 34 adjacent to and above the discharge opening 46.

Referring to FIG. 2, the power source 32 can include a power-take-off (“PTO”) output pulley 50 and a drive output pulley 52. In the present exemplary embodiment, the output pulleys 50, 52 are coaxial along a power source axis PSA. The mower deck 14 can include a plurality of driven pulleys that are rotationally connected to a respective one of the blade assemblies 36. The driven pulleys can be rotatably mounted on the top of the mower deck 14 and are typically obstructed from view in FIG. 2. However, for convenience, FIG. 2 shows the various pulleys and belts 53, 54, in solid line format. The mower deck 14 can include a blade drive belt 54 that is connected to the PTO output pulley 50 and each of the driven pulleys. The mower deck 14 can include a plurality of idler pulleys 56, 58, 60 and a tension arm 62. A mount plate 570 is shown which is attached to the frame 12 of the lawnmower 10 via welds, fasteners or combinations thereof. The mount plate 570 provides a platform to which operating pumps 501 (which form a part of a split transaxle) can be connected to the frame 12 of the lawnmower 10 via fasteners 504. In particular, the mount plate 570 can be attached to a cross frame 122 portion of frame 12, and the power source 32 can be attached to a power source frame 121 portion of frame 12.

The power source 32 can be an internal combustion engine, an electric motor or a hybrid of an internal combustion engine and an electric motor. The power source configured as an internal combustion engine or a hybrid power source can have the engine output power source axis PSA oriented in the vertical direction V of the lawnmower 10.

The drive output pulley 52 can have a propulsion belt 53 connected thereto that turns various idler pulleys as well as a power input pulley 503 connected to the operating pump 501 of a split transaxle (401, 501) power system. A separate transaxle (401, 501) can be connected to each of the wheels 18L and 18R to drive each wheel in a forward or reverse direction depending on input from the control levers 22, 24 located adjacent the lawnmower's seat 16. The propulsion belt 53 can be configured to provide a constant rotational input to the input pulley 503 of each transaxle. Thus, both the speed and the direction of rotation of each wheel 18L, 18R are controlled by the control levers 22, 24. The control levers 22, 24 can be connected to a respective swashplate in an operating pump 501 of each respective split transaxle (or to an other mechanical, hydraulic, pneumatic, or electrical mechanism that can control speed and rotational direction in a transaxle).

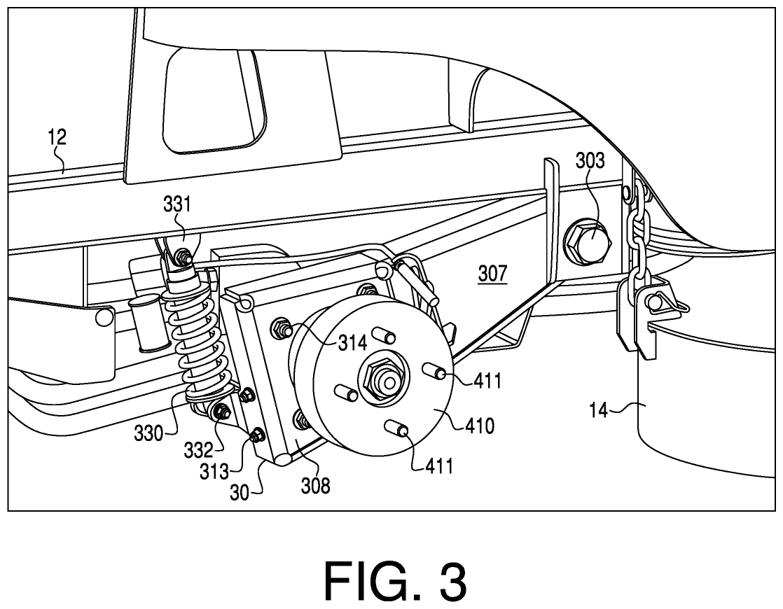

FIGS. 3-5 show in greater detail how the split transaxle (401, 501) can be connected to the lawnmower 10. FIG. 3 depicts an exemplary right suspension assembly 30 of the lawnmower 10. It should be understood that the left suspension assembly 28 can identically mirror the right suspension assembly 30, and therefore a detailed description of the left suspension assembly 28 is not included herein. The suspension assembly 30 can include an arm 307 that extends from a pivot outer collar 302 at a first end to a motor mount 308 located at an opposite end of the arm 307. The pivot outer collar 302 is connected to the frame 12 of the lawnmower 10 in a manner such that the arm 307 can pivot about a rotational pivot axis PA of the pivot outer collar 302. The motor mount 308 located at the opposite end of the arm 307 is connected to the frame 12 via a damper 330. Thus, the rotation of the suspension assembly 30 about the pivot outer collar 302 can be controlled, limited or otherwise dampened by the damper 330. The damper 330 can be a shock absorber, a strut, a simple spring or rubber block, or any other known device for cushioning or damping the movement of arm 307 relative to the frame 12 which in effect dampens the forces transmitted from the wheel 18R as it travels over the ground to an operator of the lawnmower seated on the frame 12.

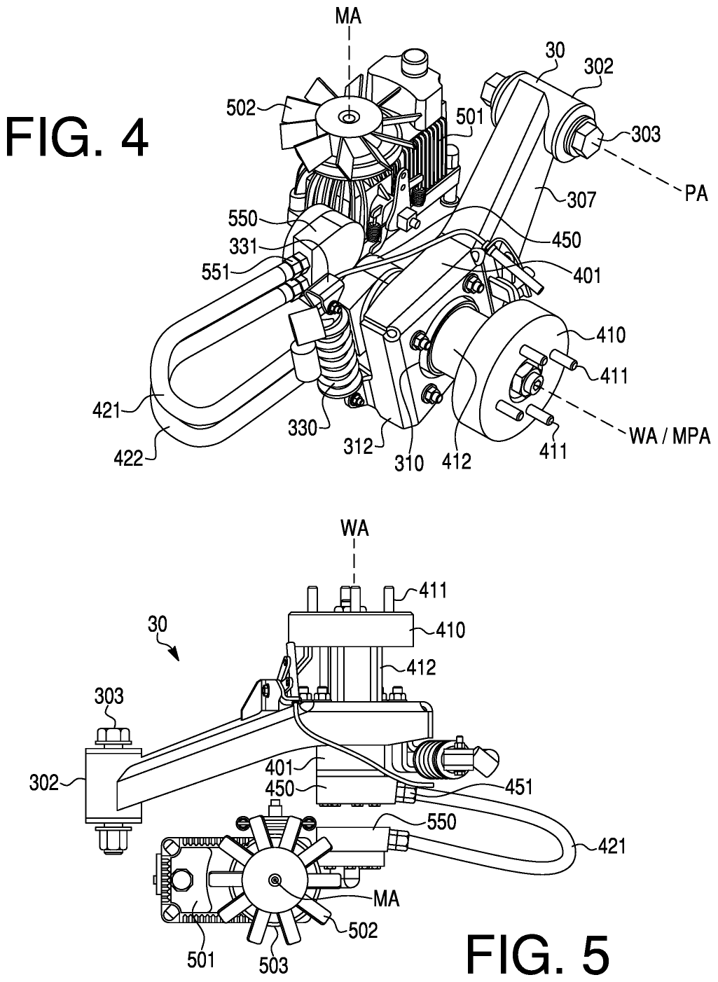

As show in FIGS. 4 and 5, the entire transaxle (401, 501) that drives the wheel 18R is not located solely on the frame 12 or solely on the suspension assembly 30. Instead, in the depicted embodiment the transaxle can be split and includes a motor pump 401 located on the suspension assembly 30 and an operating pump 501 located on the frame 12. The motor pump 401 is in fluid connection with the operating pump 501 via an output line 421 and a return line 422 that allows hydraulic fluid to be pumped from the operating pump 501 to run the motor pump 401 and then return to the operating pump 501.

The operating pump 501 can include a cooling fan 502 that is connected to a drive shaft that includes power input pulley 503. The input pulley 503 is driven by the propulsion drive belt 53 which is connected to the drive output pulley 52 connected to the output shaft of the power source 32. Thus, the input pulley 503 can be driven at a constant speed by the power source 32 of the lawnmower 10. The input pulley 503 drives fluid displacement structures located within the housing of the operating pump 501, such that the fluid displacement structures rotate about an operating pump axis MA and move fluid into/out of the operating pump 501 via output and return lines 421, 422. The speed and direction at which fluid travels within the operating pump 501 and motor pump 401 determines the speed and direction of rotation of the wheel 18R. Thus, control lever 24 can be connected to a mechanism, for example a swash plate located in the operating pump 501, that causes fluid within the pump 501 to change speed and/or direction.

The fluid arriving at the motor pump 401 via output line 421 drives fluid driven structures located within the housing of the motor pump 401, such that the fluid driven structures rotate about a motor pump axis MPA which results in rotation of the wheel shaft 412 and wheel hub 410. The wheel shaft 412 rotates about a wheel axis WA that can be coaxial with the motor pump axis MPA or about a wheel axis that is spaced from or at an angle with respect to the motor pump axis MPA.

The output line 421 and return line 422 can be connected to the operating pump 501 by an operating pump adapter 550 that can be configured as an attachment block. The output lines 421, 422 can each be configured as a hose and can include a hose connector 551 that connects the output line 421,422 in fluid communication with the operating pump adapter 550. If desired, the operating pump adapter 550 can be rotatably attached to the housing of the operating pump 501 such that if/when the output line 421 and return line 422 move with respect to the operating pump 501 the connection juncture between the lines 421, 422 and the housing of pump 501 will not significantly bend or be subject to adverse wear conditions. Similarly, output line 421 and return line 422 can be connected to the motor pump 401 by a motor pump adapter 450 that can be configured as an attachment block. The output lines 421, 422 can each include a hose connector 451 that connects each output line 421,422 in fluid communication with the motor pump adapter 450. If desired, the motor pump adapter 450 can be rotatably attached to the housing of the motor pump 401 such that if/when the output line 421 and return line 422 move with respect to the motor pump 401 the connection junctures between the lines 421, 422 and motor pump 401 will not significantly bend or be subject to adverse wear conditions. One or both of the motor pump adapter 450 and operating pump adapter 550 can be configured to rotate about an axis that is parallel with the wheel axis WA and pivot axis PA. Thus, the attachment adapters 450, 550 can rotate in a manner that prevents the rotational movement of the suspension assembly 30 to impart force onto the connection between each line 421, 422 and its respective attachment structure connected to the housings of the motor pump 401 and operating pump 501, respectively.

The motor pump 401 can be attached to the motor mount 308 portion of the suspension assembly 30 via fasteners 314 that extend through mount holes 309 located in the motor mount 308. The motor pump 401 can be operatively connected to an output such as wheel shaft 412 that in turn is connected to a wheel hub 410. Thus, when operating pump 501 drives the motor pump 401, the wheel shaft 412 is driven resulting in rotation of the wheel hub 410 and wheel 18R. The wheel shaft 412 can extend through a wheel hub throughway 310 in the motor mount 308. The wheel 18R can be connected to the wheel hub 410 via threaded attachment posts 411 extending from a face of the wheel hub 410.

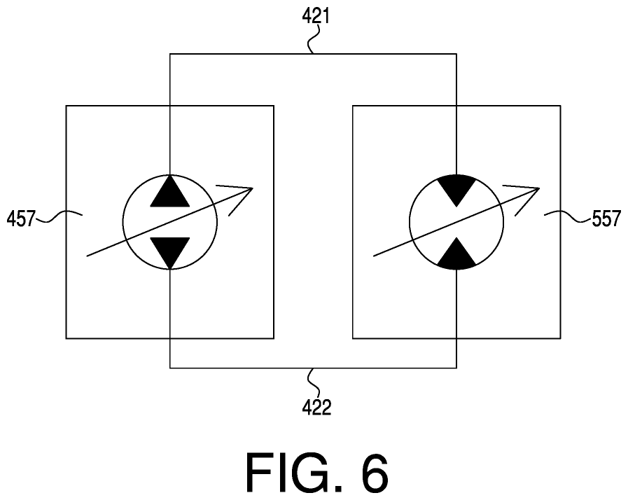

FIG. 6 is a schematic of a possible exemplary schematic relationship between the motor pump 401 and output pump 501. The operating pump 501 can include a variable displacement pump/motor 557 that is connected to the motor pump 401 via output line 421. In the embodiment of FIGS. 1-5, the motor pump 401 can be non-variable such that adjustment of the operating pump 501 causes speed and directional change to occur at wheel 18R. However, in FIG. 6, it is contemplated that the motor pump 401 can also include a variable displacement pump/motor 457 that is connected back to the operating pump 501 via return line 422 to create a closed hydraulic circuit between the motor pump 401 and operating pump 501. Thus, an operator could control either or both of the variable displacement pumps 457, 557 to ultimately control the speed and direction of rotation of the wheel 18R. Furthermore, the operating pump 501 could be non-variable while the motor pump 401 is a variable displacement pump such that only the motor pump 401 is controllable to change the direction and speed of the wheel 18R.

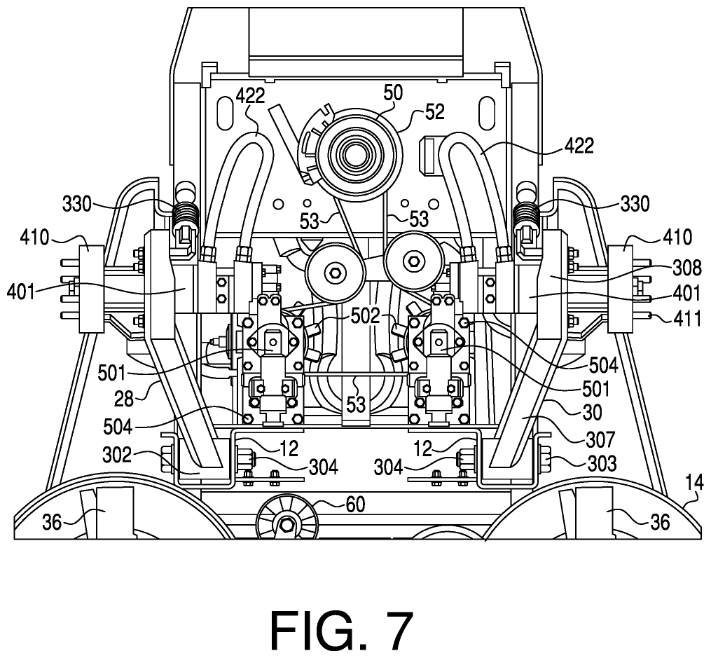

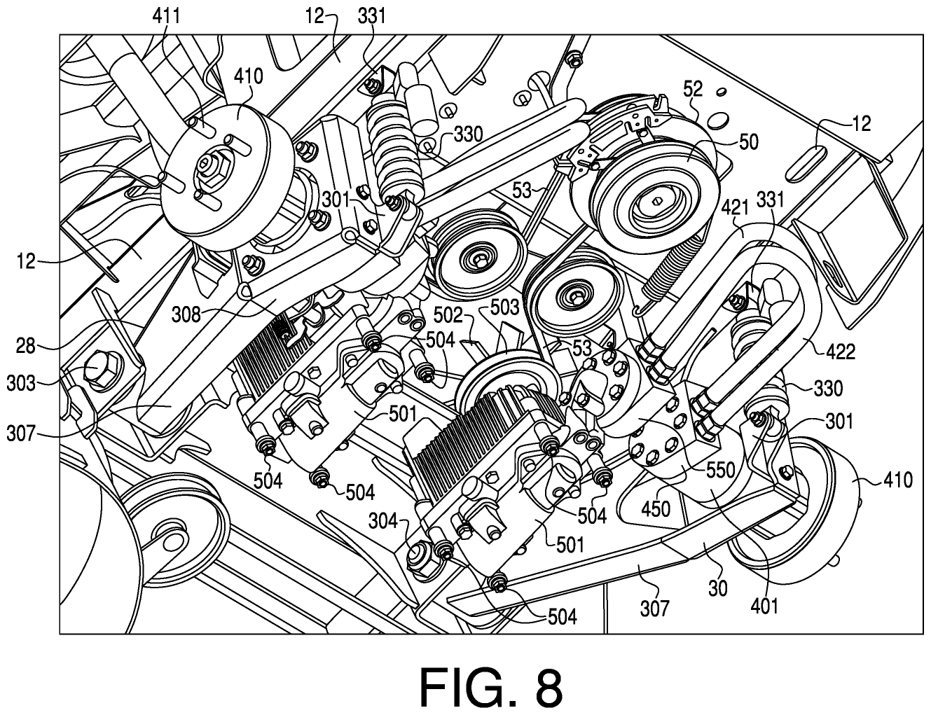

FIG. 7 is an enlarged view of a portion of FIG. 2 with the pump mount plate 570 removed to expose the rear suspension assemblies 28, 30 and the split transaxles (401, 501). FIG. 8 is a partial bottom perspective view of a rear portion of the lawnmower 10 also with the pump mount plate 570 removed to expose the rear suspension assemblies 28, 30 and the transaxles (401, 501). The separation or split between the motor pump 401 and operation pump 501 and their relative connections to the suspension assemblies 28, 30 and frame 12 are clearly shown in these views. In particular, bolt 303 connects the suspension assembly 30 to the frame 12 in a manner such that the arm 307 can rotate about a pivot axis PA that extends along the longitudinal axis of the bolt 303. The damper 330 that connects an opposite end of the suspension assembly 30 to the frame 12 includes an upper mount bracket 331 that is located at a top end of the damper 330 to secure the suspension assembly 30 to the frame 12 in a manner in which the suspension assembly 30 can move with respect to the frame 12 of the lawnmower 10. The motor pump 401 can be connected to the suspension assembly 30 at motor mount 308 via fasteners 314 and/or welds, friction fitting, or other known attachment structure, method, or material. Thus, the motor pump 401 can move with the motion of the wheel hub 410 and wheel 18L, relative to the frame 12. The damper 330 can be provided between the motor mount 308 and frame 12 to dampen the relative motion between the wheel hub 410, motor pump 401 and frame 12.

By contrast, the operating pump 501 can be attached to the frame 12 via fasteners 514 connected to the mount plate 570 such that the operating pump 501 does not move with respect to the frame 12 of the lawnmower 10. In other words, the suspension assembly 30 (or 28) is configured such that the motor pump 401 (fixedly connected to the suspension assembly 30) is moveable with respect to the operating pump 501 (fixedly connected to the frame 12). Relatively flexible hosing can be used for the output line 421 and return line 422 to provide a fluid connection between the operating pump 501 and motor pump 401 such that the above-noted relative motion can occur between the operating pump 501 and motor pump 401. Although the relative motion is shown as a rotational motion about pivot axis PA, it is contemplated that the disclosed split transaxle can be used with different types of suspension assemblies. For example, it is possible to use a suspension assembly in which linear movement occurs between the operating pump 501 and motor pump 401 (when the lawnmower 10 traverses a bump or other obstacle), or in which a more complex non-linear movement occurs between the operating pump 501 and motor pump 401 (when the lawnmower 10 traverse a bump or other obstacle).

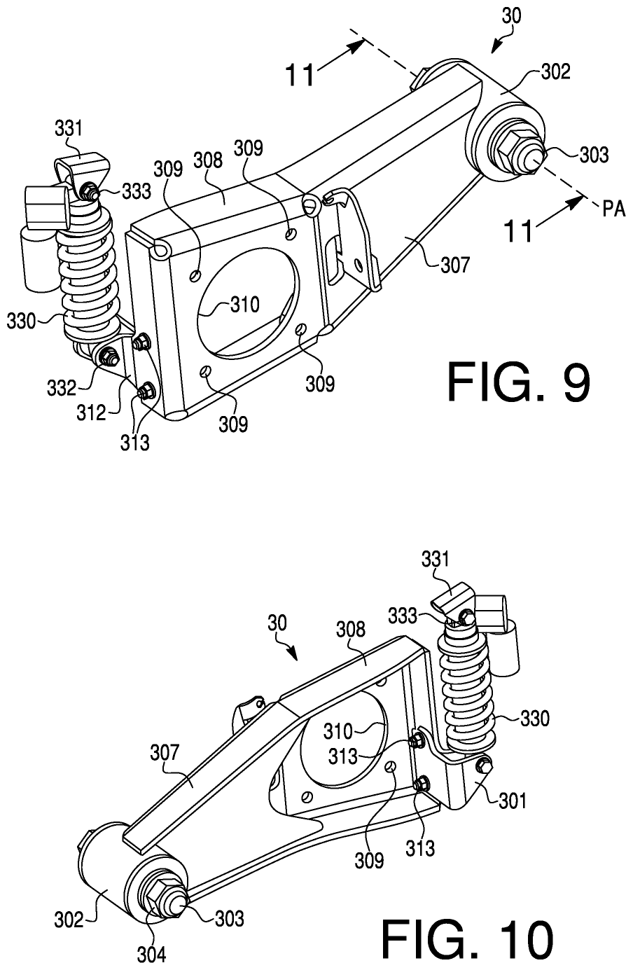

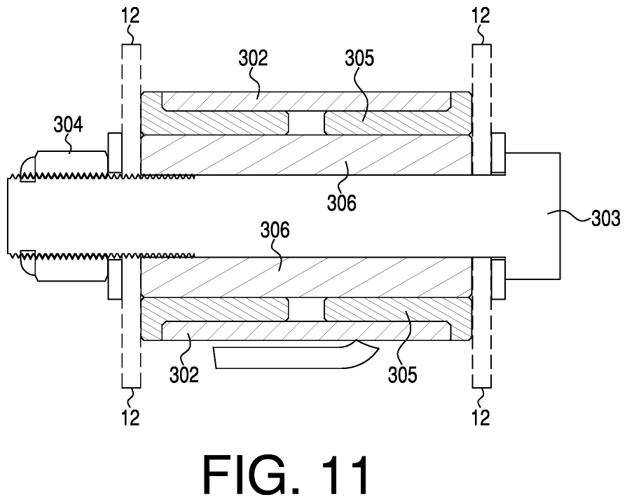

FIGS. 9 and 10 are perspective views of an outer side and an inner side, respectively, of suspension assembly 30. The suspension assembly 30 can include a pivot outer collar 302 located at a first distal end of a longitudinal axis of the suspension assembly 30. A motor mount 308 can be located at a second (opposite) distal end of the longitudinal axis of the suspension assembly 30. The collar 302 can include a bolt 303 that has a longitudinal axis that coincides with the pivot axis PA of the collar 302. Thus, the suspension assembly is configured to rotate about the longitudinal axis of bolt 303 (and pivot axis PA). As shown in detail in FIG. 11, which is a cross-sectional view taken along line 11-11 of FIG. 9, a nut 304 can be used to secure the bolt 303 to an opening in the frame 12. The collar can include a bushing 305 sandwiched between the pivot outer collar 302 and pivot inner collar 306 to allow for smooth rotation about the bolt 303. If necessary, a bearing, such as a roller bearing, can also or alternatively be provided within the pivot outer collar 302.

The arm 307 and motor mount 308 can be formed from a stamped metal part such that sufficient rigidity is provided to the suspension assembly 30. A wheel hub throughway 310 can be located in the motor mount 308 and can be surrounded by mount holes 309 such that fasteners 314 can pass therethrough to attach the motor pump 401 and wheel hub 410 to the motor mount 308. When assembled, the wheel shaft 412 of the wheel hub 410 passes through the throughway 310 of the motor mount 308. The stamped metal can be curved to form a lower mount bend 312 that can be connected to the damper 330 via fastener 332. A removable mount bracket 301 can be located opposite the mount bend 312 to form a bracket through which the fastener 332 extends and connects the damper 330 to the motor mount 308 of the suspension assembly 30. Fasteners 313 can extend through the bend 312 and fixedly connect the removeable mount bracket 301 to the motor mount 308. An upper mount bracket 331 and fastener 333 can be located at an opposite end of a longitudinal axis of the damper 330 to connect the upper end of the damper 330 to the frame 12 of the lawnmower 10. Fasteners 313, 333 and mount brackets 301, 331 can be configured to allow for some amount of rotation about the longitudinal axis of the fasteners 313, 333 which is substantially perpendicular to the longitudinal axis of the damper 330.

While certain embodiments of the invention are described above, it should be understood that the invention can be embodied and configured in many different ways without departing from the spirit and scope of the invention.

For example, while the arm 307 and motor mount 308 are depicted as being manufactured using stamped metal parts, the structures can be formed using various other materials and methods. For example, the arm 307 and motor mount 308 can be made using injection molding, casting, blow molding, extrusion, and other methods for forming structural components. The materials can be metal, metal compounds, plastics, ceramics, and even paper based product materials. The geometrical configuration for the arm 307, motor mount 308, and collar 302 can vary widely depending on the particular application. For example, the arm 307 and motor mount 308 can be I-beam or A-arm shaped, can be simple planar components (instead of the three-dimensional box configurations shown in the drawings), can be curved, straight along their entire length or other configuration that may be necessary to fit the dimensional and strength requirements for a particular application. There may also be several arms and several pivots mounted longitudinally or laterally that allow for various positions for the drive wheel 18L or 18L. Although the embodiments depicted in the drawings show the suspension arms 307 in the form of a trailing arm type suspension assembly, the suspension members can be formed in various other manners and still fall within the scope of the disclosed subject matter. For example, suspension members can be spaced out to the side instead of rearward such as in an A-arm suspension member configuration. The suspension members can also be configured as double wishbone type suspension elements, sliding pillar elements, lateral arms, dual trailing arms, swing arms, forward extending arms, or other known independent suspension member structures and still fall within the scope of the presently disclosed subject matter. Three-link, and four-link suspension components are also contemplated for use as suspension members in the presently disclosed subject matter.

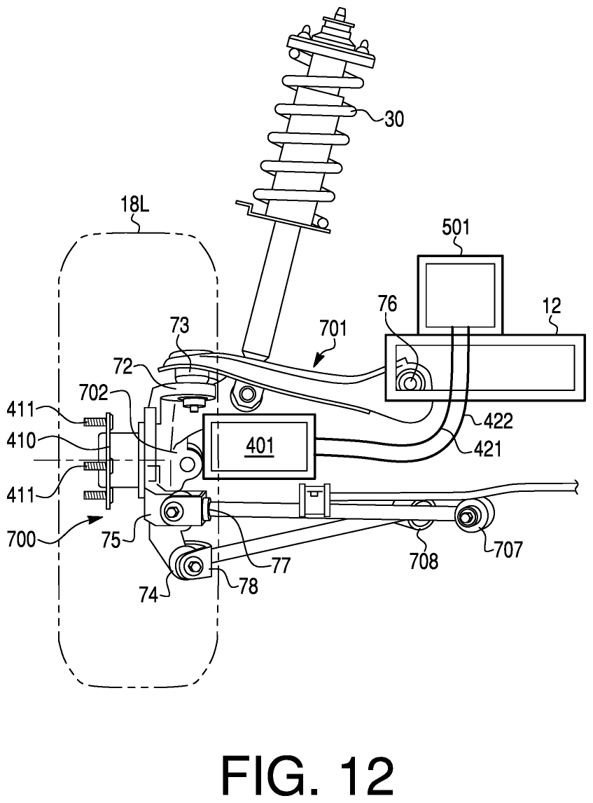

FIG. 12 shows a front view of another embodiment of a suspension assembly made in accordance with principles of the disclosed subject matter. This embodiment depicts one common type of a side extending suspension assembly 700 in which an A-arm 701 is rotatably attached at one end to vehicle frame 12 via attachment structure 76. At an opposite end, the A-arm 701 is attached to a knuckle 702 via an upper mount 72 and damper 73 for the knuckle mount. The attachment structure 76 can allow the A-arm 701 to rotate about an axis that is substantially or completely parallel with a longitudinal axis (or forward driving axis) of the vehicle (lawnmower 10). By contrast, the trailing arm 307 shown in FIG. 3 rotates about a pivot axis PA at connection bolt 303 that is substantially or completely perpendicular to the longitudinal axis LA (or forward drive axis) of the vehicle (lawnmower 10).

The knuckle 702 includes a wheel hub 410 connected thereto that allows wheel 18L to rotate about an axis that is substantially or completely perpendicular to the longitudinal axis (or forward driving axis) of the vehicle (lawnmower 10). The wheel hub 410 can include a plurality of attachment posts 411 for connecting the wheel 18L to the wheel hub 410. The lower portion of the knuckle 702 can be connected to two laterally extending support members: middle suspension bar 77; and lower suspension bar 78. The middle suspension bar 77 can be rotatably connected at its distal end to the knuckle 702 via middle mount 75 that allows for rotation about an axis that is at a slight angle with respect to the longitudinal axis (forward driving axis) of the lawnmower 10. The middle suspension bar 77 can be rotatably connected at its proximal end to the vehicle frame 12 via a frame mount 707 that allows for rotation about an axis that is at a slight angle with respect to the longitudinal axis (forward driving axis) of the lawnmower 10. The lower suspension bar 78 can be rotatably connected at its distal end to the knuckle 702 via middle mount 74 that allows for rotation about an axis that is at a slight angle with respect to the longitudinal axis (forward driving axis) of the lawnmower 10. The lower suspension bar 78 can be rotatably connected at its proximal end to the vehicle frame 12 via a frame mount 708 that allows for rotation about an axis that is at a slight angle with respect to the longitudinal axis (forward driving axis) of the lawnmower 10. A damper 30 is shown as connected to the A-arm at an end close to the wheel mount structure and knuckle 702. However, the damper 30 could also be connected to the knuckle 702 itself or to other structural members of the suspension assembly.

In this exemplary embodiment, the motor pump 401 can be directly connected to the knuckle 702 to drive the wheel hub 410 and rotate the tire 18L. The motor pump 401 will thus move with the knuckle 702 and wheel 18L as they traverse ground obstacles. The motor pump 401 can be connected via output line 421 and return line 422 to operating pump 501 which is attached to the vehicle frame 12. Thus, the operating pump 501 and motor pump 401 form a split transaxle, with the operating pump 501 and its associated weight and geometrical limitations removed and spaced from the knuckle 702. Of course, as noted above, other types of side extending suspensions are contemplated for use with this type of split transaxle that would fall within the scope of the presently disclosed subject matter, such as dual A-arm configurations, 3-link, and 4-link suspensions, as well as other known side extending suspensions. The split transaxle configuration of the presently disclosed subject matter could even be included in a lawnmower 10 that does not have a suspension system, and in which the wheels 18L and 18R are directly connected to the frame 12 itself. In this case, the operating pump 501 can be located somewhere more convenient on the frame 12 than at the wheel 18L.

In another embodiment, the housing for the motor pump 401 itself can be directly fastened to or welded to the arm 307 to form the suspension assembly 30. The damper 330 can also be welded to or fastened directly to the motor pump 401. Any of the fasteners disclosed herein can be replaced with other known attachment structures such as rivets, welds, adhesives, clamps, etc.

Exemplary embodiments are intended to include or otherwise cover any location for the split transaxle, provided one of the motor pump 401 and operating pump 501 is located on any portion of the suspension assembly 30 that is moveable with respect to the remainder of the lawnmower 10 (e.g., the frame 12 or components that are fixedly attached to the frame such that the components do not move relative to the frame 12), and the other of the motor pump 401 and operating pump 501 is fixedly attached to the remainder of the lawnmower 10. Thus, although the drawings show the motor pump 401 located at an end of the suspension assembly 30 located adjacent damper 330, the motor pump 401 could be located anywhere along the arm 307 or immediately adjacent to the collar 302. The lines 421, 422 (which can be hydraulic lines or power supply cables) extending between the motor pump 401 and operating pump 501 (which can be a hydraulic pump motor in the case of hydraulic lines or an electric motor in the case of power supply cables) can be made from various materials and configured in various shapes depending on application. For example, the lines 421, 422 could run within the arm 307 and through collar 302 in a protected environment and then through a protected conduit attached to the frame 12, if necessary. The lines 421, 422 can be construed of various materials, including plastic or polymeric material hoses, reinforced hoses (reinforced with metal webbing, tungsten, plastic webbing, carbon fiber, etc.), and other known hydraulic line materials. When lines 421, 422 are configured as power cables, the cables can be made from any commonly known or not yet know material for a power supply cable, such as steel, copper, aluminum or other known conductive metals or materials.

While the operating pump 501 is shown as being driven by a propulsion drive belt 53 that is connected to power source 32, the operating pump 501 can be powered in other ways and still be within the scope of the present disclosure. For example, the belt 53 can be replaced with a gear train connected to a power take off of the power source 32. Alternatively, a direct drive motor (electric, internal combustion, or hybrid motor) can be provided at each of the operating pumps 501 to power each operating pump 501. Further, the power source 32 can have a single operating pump 501 attached thereto that then has two pairs of lines 421, 422 extending therefrom to a respective left and right motor pump 401 located on the left and right suspension assembly 28, 30, respectively. Thus, a single operating pump 501 could be used in certain applications to power both left and right side motor pumps 401.

Although the propulsion belt 53 and blade drive belt 54 are depicted as oriented to rotate in a horizontal plane such that each of the pulleys 52, 56, 58, 503 rotate about a vertical axis that is substantially perpendicular to the pivot axis PA and wheel axis WA (and parallel with the power source axis PSA and operating pump axis MA), the orientation can be different for one or both of the belts 53, 54 and pulleys 52, 54, 56, 58, 503.

While the subject matter has been described in detail with reference to exemplary embodiments thereof, it will be apparent to one skilled in the art that various changes can be made, and equivalents employed, without departing from the scope of the invention.

1. A mower comprising:
a main frame;
a side member pivotally connected to the main frame; and
a transaxle including,
a pump portion including a pump housing fixed on the main frame and a fluid displacement structure located in the pump housing,
a motor portion including a motor housing and a fluid driven structure located in the motor housing, the motor housing being separate from the pump housing, and the motor housing being carried on and movable with the side member, and
tubing interconnecting the pump portion and the motor portion.

2. The mower according to claim 1, further comprising:
a power source mounted on the main frame at a location that is fixed with respect to the pump housing, and the power source includes an output member that rotates about an output power source axis, wherein
the pump portion includes an input member that rotates about a pump axis that is fixed with respect to the output power source axis.

3. The ride-on-mower according to claim 2, wherein
the main frame includes,
a power source frame supporting the power source,
a cross frame member spaced away from the power source frame, and
a pump mount plate fixed to and extending from each of the cross frame member and the power source frame, and
the pump housing is mounted on and supported by the pump mount plate.

4. The mower according to claim 1, further comprising:
a damper and spring assembly including a first end fixed to the main frame, wherein
the side member is a trailing arm suspension member that includes a first end pivotally mounted to the main frame such that the trailing arm is rotatable about an axis that is substantially perpendicular to a forward drive axis of the lawnmower, a second end, a damper bracket at the second end, and a motor mount adjacent to the second end,
the damper and spring assembly includes a second end fixed to the damper bracket.

5. The mower according to claim 1, wherein the tubing includes,
a flexible first hose connected to each of the pump housing and the motor housing, in fluid communication with each of a fluid displacement structure located in the pump housing and a fluid driven structure located in the motor housing, and configured to deform when the side member pivots relative to the main frame, and
a flexible second hose connected to each of the pump housing and the motor housing, in fluid communication with each of the fluid displacement structure and the fluid driven structure, and configured to deform when the side member pivots relative to the main frame.

6. The mower according to claim 1, wherein
the transaxle further includes,
a pump adapter connected to the pump housing and in fluid communication with a fluid displacement structure located in the pump housing, and
a motor adapter fixed to the motor housing and in fluid communication with a fluid driven structure located in the motor housing,
the tubing includes a flexible hose having a first hose end connected to and in fluid communication with the pump adapter and a second hose end connected to and in fluid communication with the motor adapter, and
each of the pump adapter and the motor adapter is configured to position and orient the hose such that the hose deforms in a predetermined manner when the side member pivots relative to the main frame.

7. The mower according to claim 1, wherein
the side member is a sidewards-extending suspension member that terminates at a first end and extends to a second end, the first end is pivotally mounted on the main frame such that the suspension member is rotatable about an axis that is substantially parallel with a forward drive axis of the lawnmower.

8. A self-propelled lawnmower comprising:
a main frame;
a power source attached to the main frame;
a mower deck connected to the main frame and including at least one cutting chamber;
at least one blade located in each cutting chamber;
a plurality of wheels connected to the main frame;
a suspension member connected to the main frame, the suspension member configured to move with respect to the main frame, and the suspension member configured to rotationally support at least one of the wheels; and
a transaxle configured to selectively drive the at least one of the wheels, the transaxle includes,
one of an operating pump and motor pump fixed on the main frame,
an other of the operating pump and the motor pump fixed on the suspension member, such that the motor pump moves with respect to the operating pump when the suspension member moves relative to the main frame, and
tubing interconnecting the operating pump and the motor pump.

9. The self-propelled lawnmower according to claim 8, further comprising:
a drive belt; and
an output pulley connected to and driven by the power source to rotate about a first rotational power source axis, wherein
the operating pump includes an input pulley configured to rotate about a second rotational operating pump drive axis,
the drive belt engages each of the output pulley and the input pulley, and
the second rotational operating pump drive axis is fixed with respect to the first rotational power source axis.

10. The self-propelled lawnmower according to claim 9, wherein
the motor pump is connected to a shaft and wheel hub that rotates about a wheel axis, and
the suspension member is configured such that the wheel axis moves relative to each of the first rotational power source axis and the second rotational operating pump drive axis when the suspension member moves relative to the main frame.

11. The self-propelled lawnmower according to claim 8, wherein
the suspension member is pivotally attached to the main frame at a first end of the suspension member such that the suspension member is rotatable about an axis that is substantially parallel with a forward drive axis of the lawnmower, the suspension member including a knuckle connected to at least one of the motor pump and the operating pump.

12. The self-propelled lawnmower according to claim 8, wherein
the suspension member is pivotally attached to the main frame at a first end of the suspension member such that the suspension member is rotatable about an axis that is substantially perpendicular to a forward drive axis of the lawnmower, and is attached to the motor pump at a second end of the suspension member.

13. The self-propelled lawnmower according to claim 12, wherein
the suspension member includes,
a pivot outer collar located at the first end,
a pivot inner collar inside the outer collar, and
at least one bushing between the pivot inner collar and the pivot outer collar and rotationally supporting the pivot outer collar on the pivot inner collar, and
a fastener extending through the pivot inner collar and connecting the suspension member to the main frame.

14. The self-propelled lawnmower according to claim 8, wherein
the transaxle further includes,
a pump adapter fixed to the operating pump and in fluid communication with a fluid displacement structure, and
a motor adapter fixed to the motor pump and in fluid communication with a fluid driven structure, and
the tubing includes a flexible hose having a first hose end connected to and in fluid communication with pump adapter and a second hose end connected to and in fluid communication with motor adapter.

15. A lawnmower comprising:
a main frame;
a power source mounted on the main frame;
a cutting chamber connected to the main frame;
at least one blade located in the cutting chamber;
a pair of suspension assemblies each having a first member pivotally connected to the main frame such that each of the first members pivots with respect to the main frame;
a pair of drive wheels rotatably supported by the suspension assemblies;
a first transaxle including,
a pump portion including a pump housing fixed on the main frame and a fluid displacement structure located in the pump housing,
a motor portion including a motor housing and a fluid driven structure located in the motor housing, the motor housing being spaced from the pump housing, the motor housing connected with a respective one of the suspension assemblies, and the fluid driven structure being connected to and selectively driving a respective one of the drive wheels, and
tubing interconnecting the pump portion and the motor portion.

16. The lawnmower according to claim 15, further comprising:
a second transaxle configured to drive a second one of the drive wheels independently from the first transaxle driving the first one of the drive wheels, the second transaxle includes a motor portion supported on and movable with a second one of the first members when the second one of the first members pivots relative to the main frame.

17. The lawnmower according to claim 16, wherein the second one of the first members pivots independently of a first one of the first members.

18. The lawnmower according to claim 16, wherein
the main frame includes a pump mount plate positioned between the pair of suspension assemblies, and
the pump housing and a second pump housing are mounted on and supported by the pump mount plate such that the pump housing and the second pump housing are fixed in position with respect to the power source.

19. The lawnmower according to claim 15, wherein the fluid displacement structure moves about an operating pump rotational axis, the fluid driven structure moves about a wheel rotational axis, and the wheel rotational axis moves relative to the operating pump rotational axis when a first one of the first members pivots relative to the main frame.

20. The lawnmower according to claim 15, further comprising:
an output pulley connected to and rotatable by the power source about an output power source axis;
an input pulley connected to and selectively driving the fluid displacement structure, the input pulley supported on the pump housing to rotate about an input operating pump axis that is substantially parallel to and fixed with respect to the output power source axis;
a belt engaging each of the output pulley and the input pulley; and
a wheel hub connected to and driven by the fluid driven structure, the wheel hub rotates about a wheel axis that moves relative to each of the input operating pump axis and the output power source axis.

21. The mower according to claim 1, further comprising:
a seat located adjacent the main frame and configured to allow a user to sit while operating the mower.
